(19) United States
(12) Patent Application Publication
(10) Pub. No.: US 2025/0291219 A1
(43) Pub. Date: Sep. 18, 2025

(54) LIQUID CRYSTAL DISPLAY PANEL

(71) Applicant: Guangzhou China Star Optoelectronics Semiconductor Display Technology Co., Ltd., Guangzhou (CN)

(72) Inventors: Qingjuan WANG, Guangzhou (CN); JONGWON MOON, Guangzhou (CN); Yoonsung UM, Guangzhou (CN)

(73) Assignee: Guangzhou China Star Optoelectronics Semiconductor Display Technology Co., Ltd., Guangzhou (CN)

(21) Appl. No.: 19/224,673

(22) Filed: May 30, 2025

Related U.S. Application Data
(63) Continuation of application No. PCT/CN2023/128234, filed on Oct. 31, 2023.

(30) Foreign Application Priority Data
Apr. 21, 2023 (CN) 202310444389.8

(51) Int. Cl. G02F 1/1362; G02F 1/1368

(52) U.S. Cl. CPC G02F 1/136222; G02F 1/136286; G02F 1/1368

(57) ABSTRACT

A liquid crystal display panel includes an array substrate and a color filter substrate. The array substrate includes scanning lines and a pixel electrode disposed on a first substrate, and the color filter substrate includes a color filter disposed on a second substrate. Each of the scanning lines extends in a first direction. The pixel electrode includes one or more first electrode lines each being at a first angle with the first direction and one or more second electrode lines each being at a second angle with the first direction, the first angle being greater than the second angle. The color filter includes a first part and a second part having a less color gamut value than the first part. The first part is disposed opposite to one of the first electrode lines, and the second part is disposed opposite to one of the second electrode lines.

### CROSS-REFERENCE TO RELATED APPLICATIONS

This application is a continuation of International Application No. PCT/CN2023/128234, filed on Oct. 31, 2023, which claims priority to Chinese Patent Application No. 202310444389.8, filed on Apr. 21, 2023. The disclosures of the abovementioned applications are incorporated herein by reference in their entireties.

### TECHNICAL FIELD

The present application relates to display technologies, and in particular to liquid crystal display (LCD) panels.

### BACKGROUND

LCD products having low color gamut values, such as NTSC (National Television System Committee) 45% and NTSC 60%, generally have low development costs, but require high transmittance with color gamuts appropriately reduced. Therefore, there is a need for increasing color richness (color gamut) without reducing transmittance overall.

### SUMMARY

According to some embodiments of the present application, a liquid crystal display panel includes: an array substrate including a first substrate and a plurality of scanning lines and a pixel electrode which are disposed on the first substrate; and a color filter substrate including a second substrate and a color filter disposed on the second substrate to be opposite to the pixel electrode. Each of the scanning lines extends in a first direction. The pixel electrode includes one or more first electrode lines each being at a first angle with the first direction and one or more second electrode lines each being at a second angle with the first direction, the first angle being greater than the second angle. The color filter includes a first part and a second part having a less color gamut value than the first part. The first part is disposed opposite to one of the first electrode lines, and the second part is disposed opposite to one of the second electrode lines.

According to some embodiments of the present application, a liquid crystal display panel includes: an array substrate including a first substrate and a plurality of scanning lines and a pixel electrode which are disposed on the first substrate; and a color filter substrate including a second substrate and a color filter disposed on the second substrate to be opposite to the pixel electrode. Each of the scanning lines extends in a first direction. The pixel electrode includes one or more first electrode lines each being at a first angle with the first direction and one or more second electrode lines each being at a second angle with the first direction, the first angle is greater than the second angle, and each of the first electrode lines has a greater line width than each of the second electrode lines. The color filter includes a first part and a second part having a less thickness and a less color gamut value than the first part. The first part is disposed opposite to one of the first electrode lines, and the second part is disposed opposite to one of the second electrode lines.

### BRIEF DESCRIPTION OF THE DRAWINGS

FIG. 1 is a schematic diagram of a structure of an LCD panel according to some embodiments of the present application.

FIG. 2 is a top view of a structure of an array substrate in FIG. 1 according to some embodiments of the present application.

FIG. 3 is a cross-sectional view of the array substrate in FIG. 1 according to some embodiments of the present application.

FIG. 4 is a schematic diagram of another structure of the first region and the second region of a pixel electrode in FIG. 2 according to some embodiments of the present application.

FIG. 5 is a schematic diagram of yet another structure of the first region and the second region of the pixel electrode in FIG. 2 according to some embodiments of the present application.

FIG. 6 is a top view of a pixel electrode of an LCD panel according to some embodiments of the present application.

FIG. 7 is a schematic graph showing the transmittance of LCD panels, which include respective pixel electrodes having various tilt angles, versus the drive voltage.

FIG. 8 is a schematic graph showing the transmittance of LCD panels, which include respective pixel electrodes having tilt angles of 5° and 30°, versus the drive voltage.

FIG. 9 is a top view of an array substrate of an LCD panel according to some embodiments of the present application.

### DETAILED DESCRIPTION

Some embodiments of the present application will be described in detail below with reference to the accompanying drawings. The embodiments are described for illustrative purposes only and are not intended to limit the present application.

In the present application, unless otherwise expressly specified and limited, the first feature “connects to” or “being connected with” the second feature may include the first and second features being directly connected, or may include the first and second features not being directly connected but being in contact through another feature between them. Moreover, the first feature is “above”, “on top of” or “over” the second feature include the first feature being directly above and obliquely above the second feature, or simply indicates that the first feature is higher in level than the second feature. The first feature is “below”, “on bottom of”, “under” or “beneath” the second feature include the first feature being directly below and obliquely below the second feature, or simply indicates that the first feature is lower in level than the second feature. In addition, the terms “first” and “second” are used for descriptive purposes only and cannot be understood as indicating or implying relative importance or implicitly indicating the number of technical features indicated by themselves. Therefore, the features defined as “first” and “second” may explicitly or implicitly include one or more features.

The present application provides an LCD panel including an array substrate and a color filter substrate. The array substrate includes a first substrate, scan lines and a pixel electrode, and the scan lines and the pixel electrode disposed on the first substrate. The color filter substrate includes a second substrate and a color filter disposed on the second substrate, and the color filter is disposed opposite to the pixel electrode. The extension direction of the scan line is defined as a first direction, the pixel electrode includes first electrode lines and second electrode lines, the first electrode line forms a first angle with the first direction, the second electrode line forms a second angle with the first direction, the first angle is greater than the second angle. The color filter includes a first part and a second part, the first part is disposed opposite to the first electrode line, the second part is disposed opposite to the second electrode line, and the color gamut of the first part is greater than the color gamut of the second part.

In the present application, the electrode lines inclined at two different angles. The electrode lines inclining at larger angle correspond to color filter of high color gamut, and the electrode lines inclining at less angle correspond to color filter of low color gamut. Since the threshold of voltage for deflection of liquid crystal molecules at the electrode lines inclining at larger angle is less, the voltage-transmittance (V-T) curve of the high color gamut region acts first (i.e., the V-T curve is on the left) at low grayscale. Therefore, the liquid crystal molecules at the electrode lines inclining at larger angle deflect first and display with a higher color gamut at low grayscale. Compared with a pixel electrode P with electrode lines inclining at the same angle, in the pixel structure of the present application, the color gamut is higher at low grayscale, which improves the color gamut of the entire pixel at full grayscale, achieving the effect of improving the color gamut, i.e., color gamut compensation effect at the low grayscale.

The specific implementations of the present application are described below with reference to the accompanying drawings.

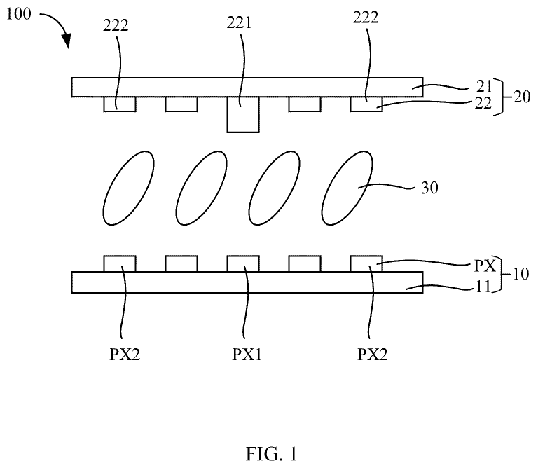

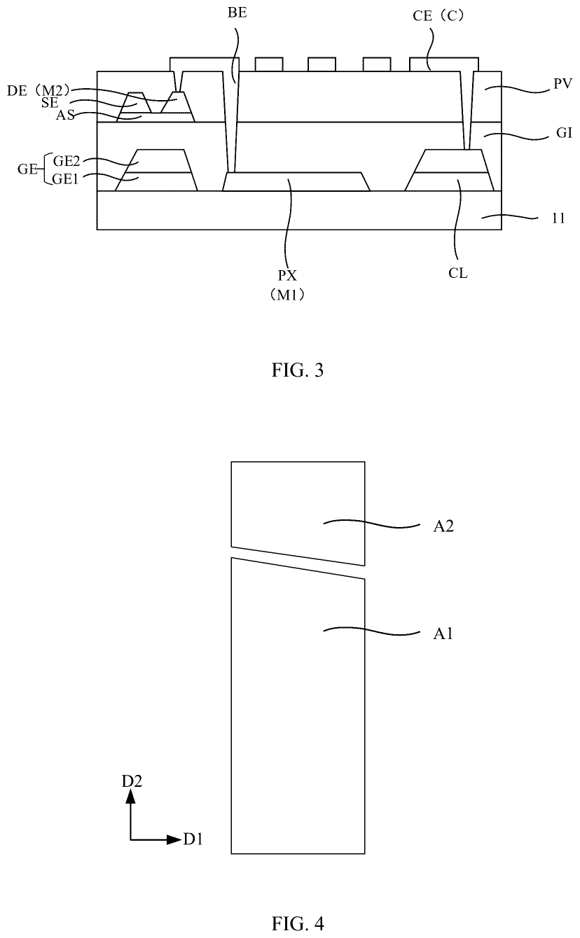

Please refer to FIG. 1 to FIG. 3, the present application provides an LCD panel 100. Specifically, the LCD panel 100 of the present application is a fringe field switching (FFS) type LCD panel. The LCD panel 100 includes an array substrate 10 and a color filter substrate 20 disposed opposite to each other, and a liquid crystal layer 30 disposed between the array substrate 10 and the color filter substrate 20.

The array substrate 10 includes a first substrate 11 and a plurality of scan lines 12 disposed in parallel, a plurality of data lines 13 disposed in parallel, a plurality of thin film transistors 14, and a plurality of pixel electrodes PX, the scan lines 12, the date lines 13, the thin film transistors 14 and the pixel electrodes PX are disposed on the first substrate 11.

The first substrate 11 is used to support various elements disposed thereon. The first substrate 11 may be a rigid substrate such as glass or plastic, or an organic flexible substrate.

The scan lines 12 intersect with the data lines 13 to define a plurality of pixel regions P. The extension direction of the scan line 12 is defined as a first direction D1, and the extension direction of the data line 13 is defined as a second direction D2. Optionally, the second direction D2 is perpendicular to the first direction D1. A thin film transistor 14 and a pixel electrode PX are provided in each pixel region P. The thin film transistor 14 includes a gate GE, a source SE, and a drain DE. The gate GE is connected to the scan line 12, the source SE is connected to the data line 13, and the drain DE is connected to the pixel electrode PX for inputting a driving voltage to the pixel electrode PX.

In some embodiments of the present application, the thin film transistor 14 is a bottom-gate thin film transistor. The array substrate 10 includes a gate layer M1, a gate insulating layer GI, a semiconductor layer AS, a source and drain metal layer M2, a passivation layer PV, and a common electrode layer C stacked in sequence.

The gate layer M1 includes the gate GE of the thin film transistor 14, the pixel electrode PX and the common electrode line CL which are disposed at intervals. That is, the pixel electrode PX is disposed in the same layer as the gate GE. Specifically, the gate GE includes a transparent conductive layer GE1 and a metal conductive layer GE2 which are stacked in sequence. The pixel electrode PX and the transparent conductive layer GE1 of the gate GE are disposed in the same layer with the same material, and they can be formed in the same process with the same transparent conductive material. The common electrode line CL and the gate GE are disposed in the same layer with the same material, and both include the transparent conductive layer GE1 and the metal conductive layer GE2 stacked in sequence, and can be formed in the same process with the same transparent conductive material. The material of the transparent conductive layer GE1 is a transparent conductive material such as indium tin oxide. The material of the metal conductive layer GE2 can be selected from copper (CU), tantalum (Ta), tungsten (W), molybdenum (Mo), aluminum (Al), titanium (Ti) or alloys thereof. The metal conductive layer GE2 can be a single layer or a multilayer. The multilayer metal conductive layer GE2 is, for example, a stack of copper (CU) and molybdenum (Mo), a stack of copper (CU) and molybdenum-titanium (MoTi) alloy, a stack of copper (CU) and titanium (Ti), a stack of aluminum (Al) and molybdenum (Mo), a stack of molybdenum (Mo) and tantalum (Ta), a stack of molybdenum (Mo) and tungsten (W), a stack of molybdenum (Mo)-aluminum (Al)-molybdenum (Mo), etc.

The gate insulating layer GI is disposed on and covers the gate GE and the common electrode line CL to isolate the gate GE and the common electrode line CL from the film layer above them. The gate insulating layer GI can be a single layer or a stack of silicon oxide, silicon nitride, silicon oxynitride, aluminum oxide, titanium oxide, etc.

The semiconductor layer AS serves as a channel of the thin film transistor 14. The material of the semiconductor layer AS may be single crystal silicon, polycrystalline silicon, low temperature polycrystalline silicon or an oxide semiconductor material. Examples of the oxide semiconductor material include indium gallium zinc oxide (IGZO), indium gallium zinc tin oxide (IGZTO), indium zinc oxide (IZO), gallium indium oxide (IGO), indium gallium tin oxide (IGTO), indium zinc tin oxide (IZTO), indium tin oxide (ITO), and the like.

The material of the source SE and the drain DE can be selected from copper (CU), tantalum (Ta), tungsten (W), molybdenum (Mo), aluminum (Al), titanium (Ti) or alloys thereof. The source SE and the drain DE can be a single layer or a multilayer. The multilayer is, for example, a stack of copper (CU) and molybdenum (Mo), a stack of copper (CU) and molybdenum-titanium (MoTi) alloy, a stack of copper (CU) and titanium (Ti), a stack of aluminum (Al) and molybdenum (Mo), a stack of molybdenum (Mo) and tantalum (Ta), a stack of molybdenum (Mo) and tungsten (W), a stack of molybdenum (Mo)-aluminum (Al)-molybdenum (Mo), etc.

The passivation layer PV is disposed on and covers the source SE and the drain DE. The passivation layer PV may be a single layer or a stacked layer of silicon oxide, silicon nitride, silicon oxynitride, aluminum oxide, titanium oxide, etc.

The common electrode layer C is disposed on the passivation layer PV. The common electrode layer C includes a common electrode CE and a bridge electrode BE insulated from the common electrode CE. One end of the bridge electrode BE is connected to the drain DE of the thin film transistor 14, and the other end is connected to the pixel electrode PX, so that the drain DE of the thin film transistor 14 is connected to the pixel electrode PX.

It can be understood that the thin film transistor 14 of the present application can also be a top-gate thin film transistor. The pixel electrode PX and the common electrode CE of the present application can also be disposed in other ways. For example, the common electrode CE is disposed on the side of the pixel electrode PX away from the first substrate 11. The common electrode CE may be a planar electrode.

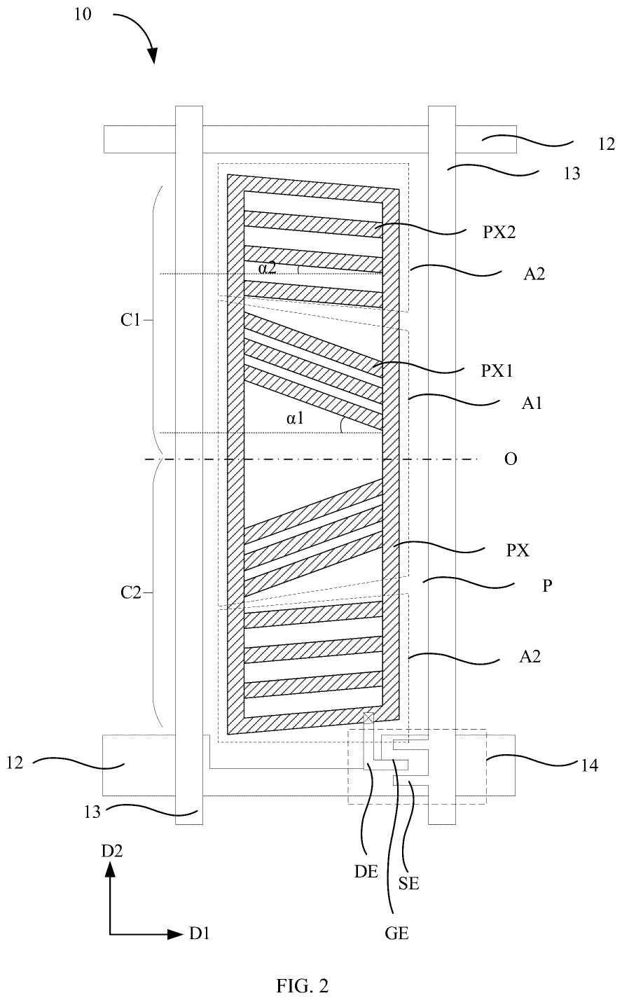

In FIG. 2, the pixel electrode PX may be partitioned into a first region A1 and a second region A2 adjacent to the first region A1. Optionally, the first region A1 and the second region A2 are arranged along the second direction D2. The pixel electrode PX may has two second regions A2, which are respectively arranged on both sides of the first region A1 along the second direction D2.

The pixel electrode PX includes a plurality of first electrode lines PX1 and a plurality of second electrode lines PX2. Two adjacent ones of the first electrode lines PX1 are spaced apart to form a slit. Two adjacent ones of the second electrode lines PX2 are spaced apart to form a slit. The material of the pixel electrode PX is a transparent conductive material such as indium tin oxide. At least one of the first electrode lines PX1 is disposed in the first region A1, and at least one of the second electrode line PX2 is disposed in the second region A2. In this embodiment, a group (including multiple) of first electrode lines PX1 is disposed in the first region A1, and a group (including multiple) of second electrode lines PX2 is disposed in the second region A2. Each of the first electrode lines PX1 forms a first angle α1 with the first direction D1, each of the second electrode lines PX2 forms a second angle α2 with the first direction D1, and the first angle α1 is greater than the second angle α2. It should be noted that the first angle α1 here is the minimum angle, or acute angle, between the first electrode line PX1 and the first direction D1, and the second angle α2 is the minimum angle, or acute angle, between the second electrode line PX2 and the first direction D1, regardless of their inclination directions.

Optionally, the pixel electrode PX is partitioned into a first domain C1 and a second domain C2 along the second direction D2. The first domain C1 is provided with at least one of the first electrode lines PX1 and at least one of the second electrode lines PX2, and the second domain C2 is also provided with at least one of the first electrode lines PX1 and at least one of the second electrode lines PX2. The first electrode line PX1 located in the first domain C1 is inclined in the opposite direction to the first electrode line PX1 located in the second domain C2, and the second electrode line PX2 located in the first domain C1 is inclined in the opposite direction to the second electrode line PX2 located in the second domain C2. Specifically, the left ends of the first electrode line PX1 and the second electrode line PX2 located in the first domain C1 are inclined away from the center line O, and the left ends of the first electrode line PX1 and the second electrode line PX2 located in the second domain C2 are inclined away from the center line O. Of course, the right ends of the first electrode line PX1 and the second electrode line PX2 located in the first domain C1 may be inclined away from the center line O, and the right ends of the first electrode line PX1 and the second electrode line PX2 located in the second domain C2 are inclined away from the center line O. Further, the first domain C1 and the second domain C2 may be symmetrical or substantially symmetrical about the center line O of the pixel region P. Further, the first electrode line PX1 located in the first domain C1 and the first electrode line PX1 located in the second domain C2 may be symmetrical about the center line O of the pixel region P, and the second electrode line PX2 located in the first domain C1 and the second electrode line PX2 located in the second domain C2 may be symmetrical about the center line O of the pixel region P.

It can be understood that the above description is made by taking the pixel electrodes PX partitioned into two domains as an example, and the pixel electrode PX of the present application may also be partitioned into four domains, six domains or eight domains.

In FIG. 1, the color filter substrate 20 includes a second substrate 21 and a color filter 22 disposed on the second substrate 21. The color filter 22 is disposed opposite to the pixel electrode PX. The color filter 22 includes first portions 221 and second portions 222. The first portion 221 is disposed opposite to the first electrode line PX1, and the second portion 222 is disposed opposite to the second electrode line PX2. It should be noted that the “an element A is disposed opposite to an element B” described herein means that in a direction perpendicular to the thickness direction of the LCD panel 100, the element A and the element B are at least partially disposed opposite to each other. The color gamut of the first portion 221 is larger than the color gamut of the second portion 222. The color gamut is used to measure the range of colors that a device can display. The larger the color gamut, the more colors it can display. Generally speaking, a wider color gamut means that the colors that can be displayed are brighter. Specifically, the color gamut in this application can be represented by the NTSC color gamut. NTSC, also known as N-system, is a color television broadcast standard established by the National Television System Committee (NTSC) in December 1952. The NTSC color gamut refers to the sum of the colors under the NTSC standard. For example, the color gamut of the first part is NTSC 72% or more and the color gamut of the second part can be NTSC 45% or less. In other words, a color filter 22 corresponds to a pixel electrode PX, and is divided into two kind of parts with different color gamut, a first part 221 with a high color gamut corresponds to a first electrode line PX1 inclining at a large angle, and a second part 222 with a low color gamut corresponds to a second electrode line PX2 inclining at a small angle. Specifically, the thickness of the first part 221 is greater than the thickness of the second part 222; and/or the material of the first part 221 has a higher color gamut than the material of the second part 222. By adjusting the thickness and material of the color filter 22, its color gamut can be adjusted. For example, when the material of the first part 221 is same as the material of the second part 222, the thickness of the first part 221 is greater than the thickness of the second part 222. When the thickness of the first part 221 is equal to the thickness of the second part 222, the material of the first part 221 has a higher color gamut than the material of the second part 222. In addition, the color filter includes a red color filter, a green color filter, or a blue color filter. For a pixel of each color, the corresponding color filter can be provided with a first part 221 and a second part 222 for compensation.

In FIG. 4, according to other embodiments of the present application, the pixel electrode PX may also include only one first region A1 and one second region A2, and the present application does not limit the numbers of the first and second region. Optionally, the first region A1 occupies less than 40% of the total area of the pixel electrode PX, and the second region A2 occupies more than 60% of the total area of the pixel electrode PX.

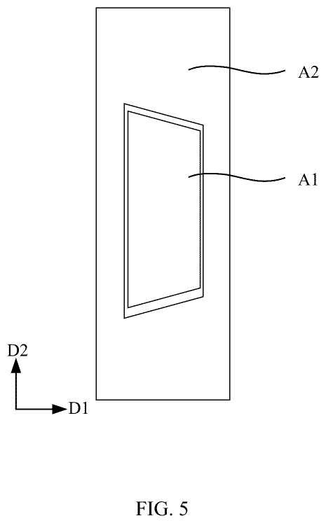

In FIG. 5, according to other embodiments of the present application, the second region A2 may be arranged around the first region A1, or the first region A1 may be arranged around the second region A2. Specifically, the second region A2 is rectangular and has an opening, and the first region A1 is trapezoidal and located in the opening of the second region A2.

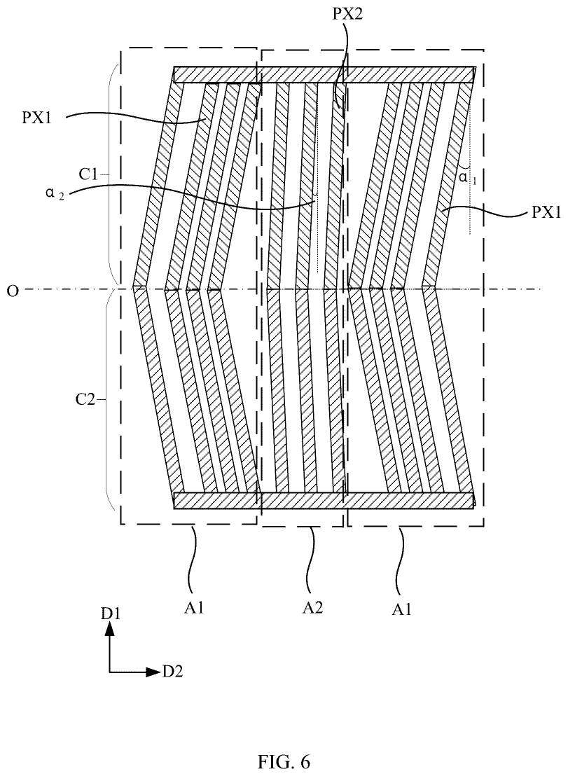

In FIG. 6, according to other embodiments of the present application, the first region A1 and the second region A2 may be arranged along a second direction D2. Specifically, the pixel electrode PX may include two first regions A1, and the two first regions A1 are respectively arranged on both sides of the second region A2 along the second direction D2. The pixel electrode PX includes a plurality of first electrode lines PX1 and a plurality of second electrode lines PX2. Two adjacent ones of the first electrode lines PX1 are spaced apart to form a slit. Two adjacent ones of the second electrode lines PX2 are also spaced apart to form a slit.

The pixel electrode PX is partitioned into a first domain C1 and a second domain C2 along a first direction D1. Different from the embodiment shown in FIG. 2, a group (including multiple) of the first electrode lines PX1, a group (including multiple) of the second electrode lines PX2, and another group (including multiple) of the first electrode lines PX1 are sequentially disposed from left to right along the second direction in the first domain C1. Corresponding to the first domain C1, a group (including multiple) of the first electrode lines PX1, a group (including multiple) of the second electrode lines PX2, and another group (including multiple) of the first electrode lines PX1 are sequentially disposed from left to right along the second direction in the second domain C2. The first electrode line PX1 located in the first domain C1 are inclined in opposite direction to the first electrode line PX1 located in the second domain C2. The second electrode line PX2 located in the first domain C1 are inclined in opposite direction to the second electrode line PX2 located in the second domain C2. Specifically, the ends of the first electrode line PX1 and the second electrode line PX2 in the first domain C1 away from the center line O are inclined toward the right side, and the ends of the first electrode line PX1 and the second electrode line PX2 in the second domain C2 away from the center line O are inclined toward the right side. Further, the first domain C1 and the second domain C2 may be symmetrical or substantially symmetrical about the center line O of the pixel region P. The first electrode line PX1 located in the first domain C1 and the first electrode line PX1 located in the second domain C2 may be symmetrical about the center line O of the pixel region P, and the second electrode line PX2 located in the first domain C1 and the second electrode line PX2 located in the second domain C2 may be symmetrical about the center line O of the pixel region P.

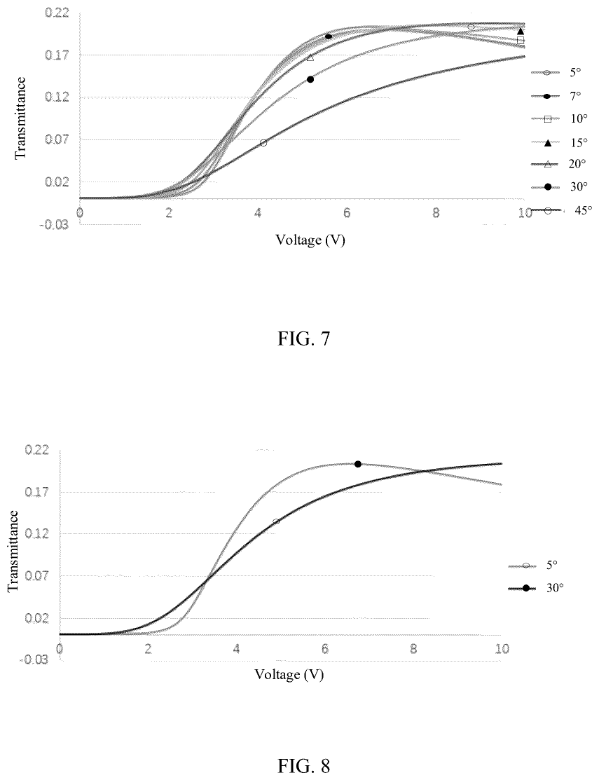

FIG. 7 is a schematic graph showing the transmittance of LCD panels, which include respective pixel electrodes having various tilt angles, versus the drive voltage, where the horizontal axis represents the pixel voltage in V, and the vertical axis represents the transmittance. As can be seen from FIG. 7, the larger the angle between the electrode line of the pixel electrode PX and the first direction D1, the greater the initial power of the liquid crystal, the easier it is to start the liquid crystal at a low voltage, and the less the threshold of voltage Vth for driving the liquid crystal molecules to deflect. For example, the Vth of the pixel electrode PX with an angle of 20°, 30°, and 45° is less than the Vth of the pixel electrode PX with an angle of 5° and 7°. Utilizing this characteristic, the present application sets the first region A1 with a larger angle of inclination as a high color gamut region. For the high color gamut region, compared with other regions with less angles of inclination (such as the second region A2 in FIG. 2 or FIG. 6), the VT curve acts first at low grayscale, the brightness is higher, the color gamut is larger, and the color gamut compensation effect is achieved. The VT curve in the high color gamut area acts first (the VT curve is on the left), the transmittance is higher than other areas at low grayscale, the color gamut is high, and the color gamut of the entire pixel at low grayscale is increased, achieving color gamut compensation effect at low grayscale.

Optionally, the first angle α1 is 15° to 45°, and the second angle α2 is 0° to 10°. For example, the first angle α1 can be 15°, 20°, 25°, 30°, 35°, 40, 45°, and the second angle α2 can be 0°, 1°, 2°, 3°, 4°, 5°, 6°, 7°, 8°, 9°, 10°. A large gap is formed between the first angle α1 and the second angle α2, thereby achieving a good compensation effect. In a specific embodiment, the first angle α1 is 30° and the second angle α2 is 5°. It can be seen from the simulation data shown in FIG. 8 that the difference between the Vth corresponding to the first and second angles is 0.5 V, and the compensation effect of the brightness and the color gamut under low grayscale can be achieved.

Optically, the total area occupied by the first electrode lines PX1 accounts for 2% to 30% of the area of the pixel opening region. The pixel opening region refers to a pixel region P minus the area occupied by the scan line 12, the data line 13 and the thin film transistor 14. For example, the total area occupied by the first electrode lines PX1 may account for 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30% of the area of the pixel opening region. If the area occupied by the first electrode lines PX1 corresponding to the high color gamut region is too small, the compensation effect cannot be achieved. If the area occupied by the first electrode line PX1 corresponding to the high color gamut region is too large, the voltage at the brightest state is larger, the V-T curve act first at low grayscale, and the voltage at the maximum brightness is higher.

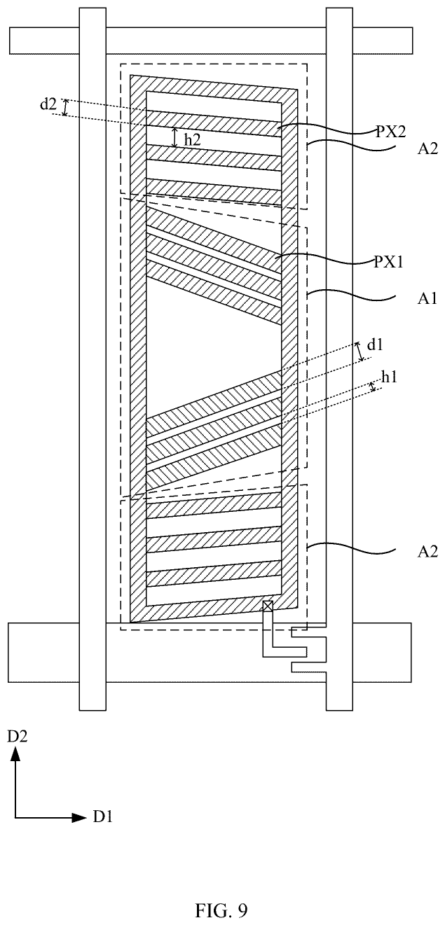

Optionally, as shown in FIG. 9, the threshold of voltage Vth for activation of the liquid crystal can also be adjusted by adjusting the line width and line spacing of the electrode lines. Specifically, the line width d1 of the first electrode line PX1 is greater than the line width d2 of the second electrode line PX2; and/or the line spacing h1 of adjacent two first electrode lines PX1 is less than the line spacing h2 of adjacent two second electrode lines PX2. The larger the line width or the less the line spacing, the greater the density of the electrode lines, and the less the corresponding threshold of voltage Vth for activation of the liquid crystal.

Some embodiments of the present application have been described in detail above. The description of the above embodiments merely aims to help to understand the present application. Many modifications or equivalent substitutions with respect to the embodiments may occur to those of ordinary skill in the art based on the present application. Thus, these modifications or equivalent substitutions shall fall within the scope of the present application.

What is claimed is:

1. A liquid crystal display panel, comprising:
an array substrate comprising a first substrate and a plurality of scanning lines and a pixel electrode which are disposed on the first substrate; and
a color filter substrate comprising a second substrate and a color filter disposed on the second substrate to be opposite to the pixel electrode,
wherein each of the scanning lines extends in a first direction;
the pixel electrode comprises one or more first electrode lines each being at a first angle with the first direction and one or more second electrode lines each being at a second angle with the first direction, the first angle is greater than the second angle, and each of the first electrode lines has a greater line width than each of the second electrode lines;
the color filter comprises a first part, and a second part having a less thickness and a less color gamut value than the first part; and
the first part is disposed opposite to one of the first electrode lines, and the second part is disposed opposite to one of the second electrode lines.

2. The liquid crystal display panel according to claim 1, wherein the first angle is 15° to 45°, and the second angle is 0° to 10°.

3. The liquid crystal display panel according to claim 1, wherein the first angle is 20° to 30°, and the second angle is 5° to 8°.

4. The liquid crystal display panel according to claim 1, wherein a total area of the first electrode lines accounts for 2% to 30% of an area of a pixel opening region.

5. The liquid crystal display panel according to claim 1, wherein the pixel electrode has a first region and a second region that are arranged along a second direction perpendicular to the first direction; and
the first electrode lines are located in the first region, and the second electrode lines are located in the second region.

6. The liquid crystal display panel according to claim 1, wherein the one or more first electrode lines comprise a plurality of first electrode lines, and the one or more second electrode lines comprise a plurality of second electrode lines; and
a distance between two adjacent ones of the first electrode lines is less than a distance between two adjacent ones of the second electrode lines.

7. The liquid crystal display panel according to claim 1, wherein a material of the first part has a greater color gamut value than a material of the second part.

8. The liquid crystal display panel according to claim 1, wherein the color gamut value of the first part is not less than NTSC 72%, and the color gamut value of the second part is not more than NTSC 45%.

9. The liquid crystal display panel according to claim 1, wherein the one or more first electrode lines comprise a plurality of first electrode lines, and the one or more second electrode lines comprise a plurality of second electrode lines;
the pixel electrode has a first domain and a second domain that are arranged along one of the first direction and a second direction perpendicular to the first direction;
a first portion of the first electrode lines and a first portion of the second electrode lines are disposed in the first domain, and a second portion of the first electrode lines and a second portion of the second electrode lines are disposed in the second domain; and
each of the first portion of the first electrode lines inclines in a direction opposite to a direction in which each of the second portion of the first electrode lines inclines, and each of the first portion of the second electrode lines inclines in a direction opposite to a direction in which each of the second portion of the second electrode lines inclines.

10. The liquid crystal display panel according to claim 1, wherein the array substrate further comprises a thin film transistor, a common electrode line and a common electrode;
the thin film transistor comprises a gate, a source and a drain;
the gate, the pixel electrode and the common electrode line are disposed in a same layer; and
the common electrode is disposed on a side of the pixel electrode away from the first substrate and is a planar electrode.

11. A liquid crystal display panel, comprising:
an array substrate comprising a first substrate and a plurality of scanning lines and a pixel electrode which are disposed on the first substrate; and
a color filter substrate comprising a second substrate and a color filter disposed on the second substrate to be opposite to the pixel electrode,
wherein each of the scanning lines extends in a first direction;
the pixel electrode comprises one or more first electrode lines each being at a first angle with the first direction and one or more second electrode lines each being at a second angle with the first direction, the first angle being greater than the second angle;
the color filter comprises a first part and a second part having a less color gamut value than the first part; and
the first part is disposed opposite to one of the first electrode lines, and the second part is disposed opposite to one of the second electrode lines.

12. The liquid crystal display panel according to claim 11, wherein the first angle is 15° to 45°, and the second angle is 0° to 10°.

13. The liquid crystal display panel according to claim 11, wherein the first angle is 20° to 30°, and the second angle is 5° to 8°.

14. The liquid crystal display panel according to claim 11, wherein a total area of the first electrode lines accounts for 2% to 30% of an area of a pixel opening region.

15. The liquid crystal display panel according to claim 11, wherein the pixel electrode has a first region and a second region that are arranged along a second direction perpendicular to the first direction; and
the first electrode lines are located in the first region, and the second electrode lines are located in the second region.

16. The liquid crystal display panel according to claim 11, wherein each of the first electrode lines has a greater line width than each of the second electrode lines; and/or
the one or more first electrode lines comprise a plurality of first electrode lines, the one or more second electrode lines comprise a plurality of second electrode lines, and a distance between two adjacent ones of the first electrode lines is less than a distance between two adjacent ones of the second electrode lines.

17. The liquid crystal display panel according to claim 11, wherein a thickness of the first part is greater than a thickness of the second part; and/or
a material of the first part has a greater color gamut value than a material of the second part.

18. The liquid crystal display panel according to claim 11, wherein the color gamut value of the first part is not less than NTSC 72%, and the color gamut value of the second part is not more than NTSC 45%.

19. The liquid crystal display panel according to claim 11, wherein the one or more first electrode lines comprise a plurality of first electrode lines, and the one or more second electrode lines comprise a plurality of second electrode lines;
the pixel electrode has a first domain and a second domain that are arranged along one of the first direction and a second direction perpendicular to the first direction;
a first portion of the first electrode lines and a first portion of the second electrode lines are disposed in the first domain, and a second portion of the first electrode lines and a second portion of the second electrode lines are disposed in the second domain; and
each of the first portion of the first electrode lines inclines in a direction opposite to a direction in which each of the second portion of the first electrode lines inclines, and each of the first portion of the second electrode lines inclines in a direction opposite to a direction in which each of the second portion of the second electrode lines inclines.

20. The liquid crystal display panel according to claim 11, wherein the array substrate further comprises a thin film transistor, a common electrode line and a common electrode;
the thin film transistor comprises a gate, a source and a drain;
the gate, the pixel electrode and the common electrode line are disposed in a same layer; and
the common electrode is disposed on a side of the pixel electrode away from the first substrate and is a planar electrode.
